(19) United States
(12) Patent Application Publication
(10) Pub. No.: US 2009/0224095 A1
(43) Pub. Date: Sep. 10, 2009

(54) DUCTED VERTICAL TAKE-OFF AND LANDING (VTOL) PERSONNEL CARRIER

(75) Inventors: Paul Alan Cox, Albuquerque, NM (US); Emray Goossen, Albuquerque, NM (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/042,030

(22) Filed: Mar. 4, 2008

(51) Int. Cl. B64C 27/08

(52) U.S. Cl. 244/17.23

(57) ABSTRACT

A vertical take-off and landing (VTOL) vehicle includes a first thruster, a first duct, a second thruster, a second duct, an engine pod, and a transport unit. The first duct is configured to direct airflow generated by the first thruster. The second duct is configured to direct airflow generated by the second thruster. The engine pod is formed between the first duct and the second duct. The transport unit is formed between the first duct and the second duct, and is configured to transport a person or another payload. The transport unit is alternatively a person transport or a surveillance package pod.

### TECHNICAL FIELD

The present invention relates to vehicle systems and, more particularly, to vertical take-off and landing vehicles.

### BACKGROUND

Vertical take-off and landing (VTOL) vehicles are often used in providing reconnaissance, among other functions, and allow access to areas that may not be feasible with conventional aircraft. In particular, ducted fan VTOL vehicles are known for superior stationary aerodynamic hovering performance and low speed flights.

However, typical VTOL vehicles are not designed to transport people, as may be desired for example for covert deployment of personnel or extraction of injured personnel from rough terrain or a hostile environment. Additionally, other devices used for covert deployment of personnel or extraction of injured personnel from rough terrain or a hostile environment may be less than optimal. For example, the use of helicopters, parachutes, or ground vehicles for such missions may be less precise and/or more expensive, may place additional personnel at risk, and/or may have a relatively higher visual and acoustic signature as compared with a VTOL vehicle.

Accordingly, it is desirable to provide an improved VTOL vehicle for transporting a person, for example for covert deployment of personnel or extraction of injured personnel from rough terrain or a hostile environment. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment of the present invention, a vertical take-off and landing (VTOL) vehicle is provided. The VTOL vehicle comprises a first thruster, a first duct, a second thruster, a second duct, and a transport unit. The first duct is configured to direct airflow generated by the first thruster. The second duct is configured to direct airflow generated by the second thruster. The transport unit is formed between the first duct and the second duct, and is configured to transport a person or another payload.

In accordance with another exemplary embodiment of the present invention, a vertical take-off and landing (VTOL) vehicle is provided. The VTOL vehicle comprises a body, a first fan, a first duct, a second fan, a second duct, and a transport unit. The first fan is housed within the body, and is configured to rotate in a first direction. The first duct is housed within the body, and is configured to direct airflow generated by the first fan. The second fan is housed within the body, and is configured to rotate in a second direction that is counter to the first direction. The second duct is configured to direct airflow generated by the second fan. The transport unit is housed within the body between the first duct and the second duct, and is configured to transport a person or another payload.

In accordance with a further exemplary embodiment of the present invention, a vertical take-off and landing (VTOL) vehicle is provided. The VTOL vehicle comprises a body, a first fan, a first duct, a second fan, a second duct, and a transport unit. The first fan is housed within the body, and is configured to rotate in a first direction. The first duct is housed within the body, and is configured to direct airflow generated by the first fan. The second fan is housed within the body, and is configured to rotate in a second direction that is counter to the first direction. The second duct is housed within the body, and is configured to direct airflow generated by the second fan. The transport unit is housed within the body between the first duct and the second duct, and is adaptable between a first configuration and a second configuration. In the first configuration, the transport unit comprises a gurney. In the second configuration, the transport unit comprises a chair.

### BRIEF DESCRIPTION OF THE DRAWINGS

FIG. 1 is a perspective drawing of a vertical take-off and landing (VTOL) vehicle in which the transport unit comprises a surveillance pod, in accordance with an exemplary embodiment of the present invention;

FIG. 2 is a perspective drawing of another embodiment of the VTOL vehicle of FIG. 1, in which the transport unit comprises a backboard and cover, in accordance with an exemplary embodiment of the present invention;

FIG. 3 provides a section view of a portion of the VTOL vehicle embodiment of FIG. 2, namely the backboard and cover; and

FIG. 4 is a perspective drawing of another embodiment of the VTOL vehicle of FIG. 1, in which the transport unit comprises a chair, in accordance with an exemplary embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. For example, although the following description and the referenced Figures make reference to a double ducted fan hovering air vehicle, it will be appreciated that the present invention may also apply to vehicles having more than two ducts. Other particular configurations and exemplary embodiments discussed herein may similarly be varied, and are not intended to limit the scope of the invention.

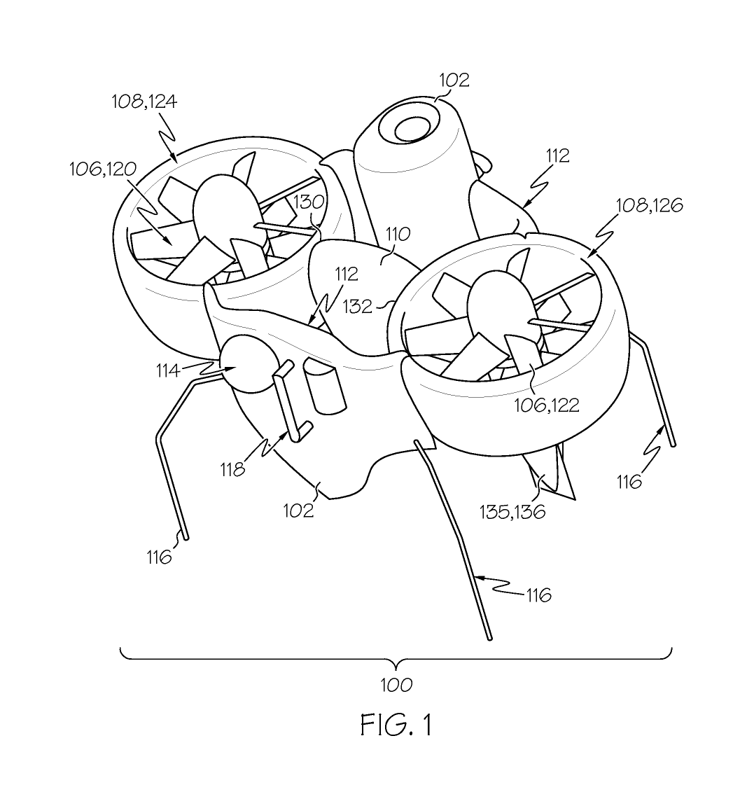

FIG. 1 is a perspective drawing of a vertical take-off and landing (VTOL) vehicle 100 having a transport unit 110, in accordance with an exemplary embodiment of the present invention. As shown in FIG. 1, in the depicted embodiment the VTOL vehicle 100 comprises an engine 102, thrusters 106, ducts 108, and a payload transport unit 110. Also as shown in FIG. 1, the VTOL vehicle 100 may also include one or more pods 112 (two are depicted in FIG. 1), one or more sensors 114 (one is depicted in FIG. 1), landing gear 116, and a capture bar 118.

Each duct 108 with the adjoining pods 112 together for the VTOL body of the VTOL vehicle 100, and are configured along with the thrusters 106 to generate an airflow to at least facilitate movement of the VTOL vehicle 100 as a whole. In the depicted embodiment, each thruster 106 comprises a fan 106 powered and operated by an engine 102; however, this may vary in other embodiments. Specifically, in the depicted embodiment, the thrusters 106 comprise a first thruster 120 and a second thruster 122. The first thruster 120 comprises a first fan 120 housed within the first duct 124 and configured to rotate in a first direction. The second thruster 122 comprises a second fan 122 housed within the second duct 126 and configured to rotate in a second direction that is counter to the first direction.

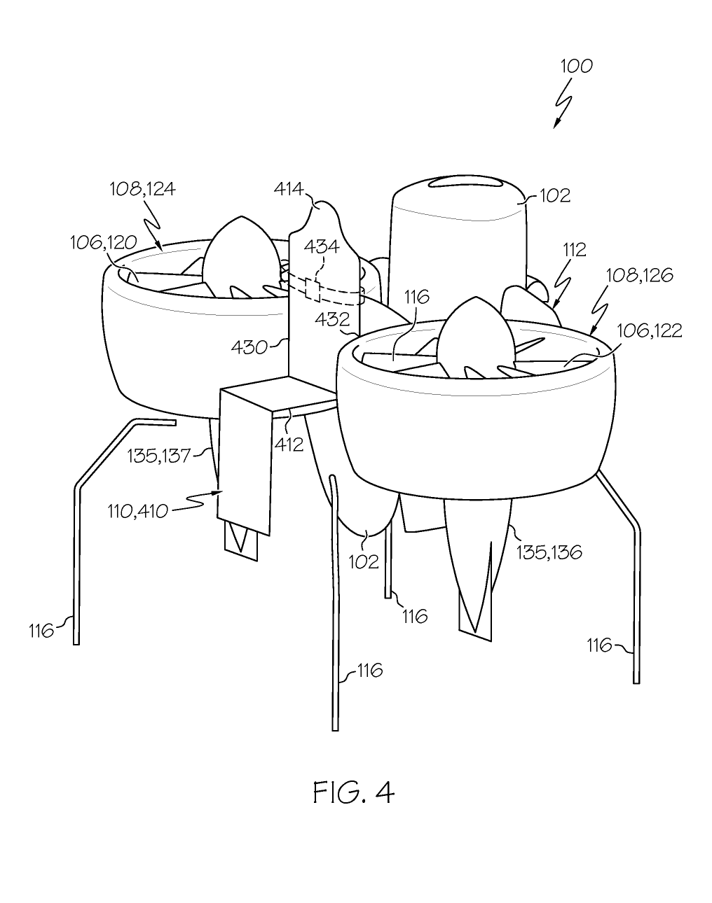

Each duct 108 is coupled to a respective thruster 106, and is configured with control vanes 135 (preferably, a different control vane 135 for each respective thruster 106) to direct the airflow generated by the respective thruster 106. Specifically, in the depicted embodiment, the ducts 108 comprise a first duct 124 and a second duct 126. The first duct 124, is coupled to the first thruster 120, and is configured with a first control vane 136 to direct the airflow generated by the first thruster 120. The second duct 126, is coupled to the second thruster 122, and is configured with a second control vane 137 (not depicted in FIG. 1, but depicted in FIG. 4 in accordance with an exemplary embodiment) to direct the airflow generated by the second thruster 122. As depicted in FIG. 1, the first duct 124 and the second duct 126 are aligned side-by-side along a lateral plane in a preferred embodiment of the present invention.

While the VTOL vehicle 100 is depicted in FIG. 1 as a double ducted VTOL vehicle having two fans 106 and two corresponding ducts 108, it will be appreciated that this may vary in other embodiments. For example, in certain embodiments, the VTOL vehicle 100 may have three or more fans 106 and/or other thrusters 106, each having a corresponding duct 108 that is configured to direct the airflow generated by its respective fan 106 or other thruster 106. Various other features may also vary in other embodiments. However, regardless of the number of fans 106 or other thrusters 106 and/or the number of corresponding ducts 108, each of the ducts 108 are preferably aligned side-by-side along a lateral plane.

The transport unit 110 is formed between the first duct 124 and the second duct 126, and is configured to transport a person or another payload, for example for covert deployment of personnel or extraction of injured personnel from rough terrain or a hostile environment. In one preferred embodiment, the transport unit 110 is housed within the VTOL vehicle 100 between the first duct 124 and the second duct 126 and between the pods 112, as shown in FIG. 1. This may vary in certain embodiments, as may the number of pods 112. Also in a preferred embodiment, the transport unit 110 includes a first end 130 attached to the first duct 124 and a second end 132 attached to the second duct 126, as is also shown in FIG. 1.

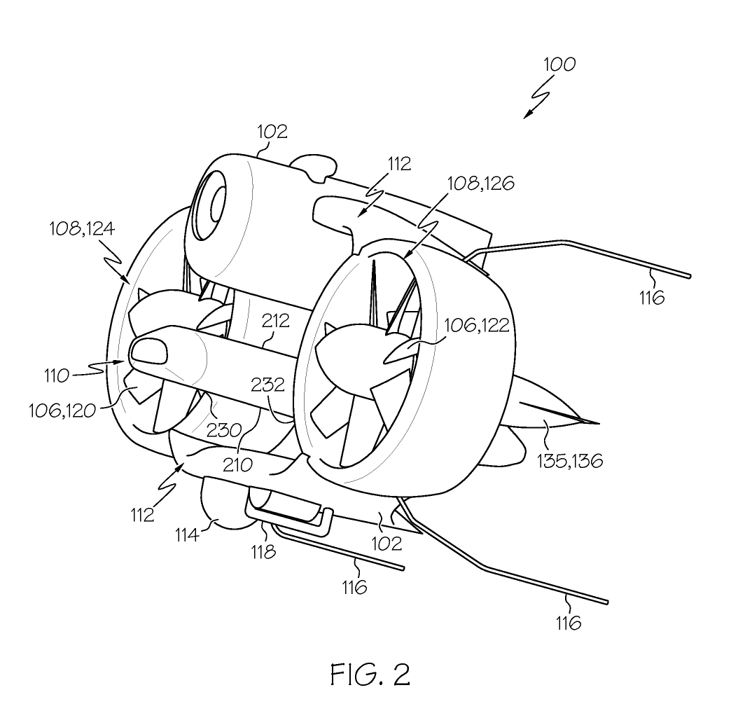

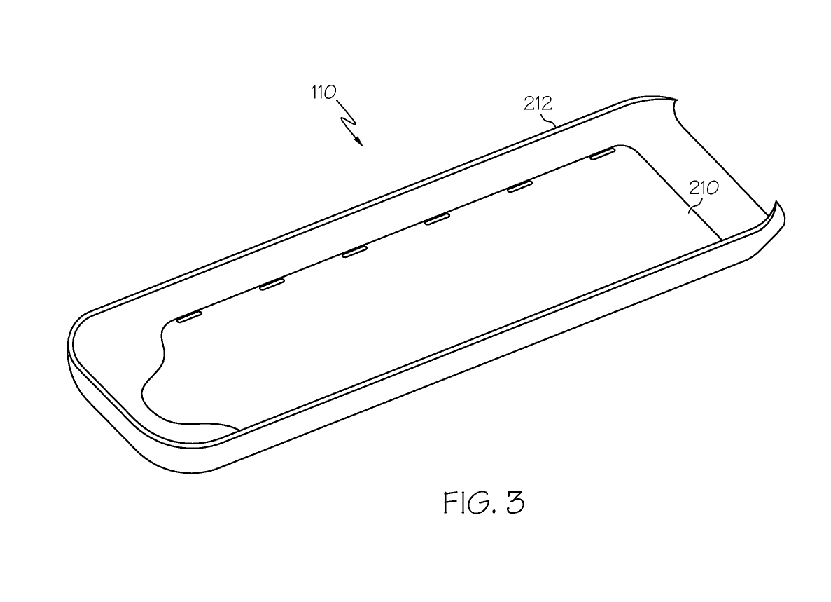

The transport unit 110 may take any one or more of a number of different configurations for carrying a payload or a backboard and cover containing a person, depending on the particular embodiment. FIGS. 2 and 3 depict one preferred embodiment for the transport unit 110, comprising a backboard and cover that will be described further below in connection with FIGS. 2 and 3. FIG. 4 depicts another preferred embodiment for the transport unit 110, comprising a chair that will be described further below in connection with FIG. 4.

In one preferred embodiment, the transport unit 110 can be converted between multiple configurations, such as between the backboard and cover of FIGS. 2 and 3, the chair of FIG. 4, and/or other configurations as in FIG. 1. In other embodiments, the transport unit 110 may be fixed in its configuration. For example, in certain other embodiments, the transport unit 110 may be fixed as a backboard and cover, a chair, or some other configuration. As alluded to above, the transport unit 110 can take various other different configurations in other embodiments, and/or can be converted between these configurations and/or various other configurations in certain embodiments.

As referenced above, in the depicted embodiment of FIG. 1, the VTOL vehicle 100 also includes one or more sensors 114, landing gear 116, and a capture bar 118. The one or more sensors 114 preferably are also attached to the pod 112, and are configured to sense objects and/or other conditions surrounding the VTOL vehicle 100 and to facilitate operation thereof. The landing gear 116 is attached to the duct 108 and pod 112 attachment points, and facilitates landing of the VTOL vehicle 100. The capture bar 118 is attached to, coupled to, or formed integral with the pod 112, and is configured to assist with capture of the VTOL vehicle 100, for example by being engaged by a non-depicted capture device. In the depicted embodiment, the capture bar 118 extends from the pod 112. In other embodiments, the capture bar 118 may be implemented as a bar recessed in the pod 112, shown in FIG. 1, or may be otherwise attached to, coupled to, or formed integral with the ducts 108. It will be appreciated that these and/or other components of the VTOL vehicle 100 may vary in other embodiments.

FIG. 2 is a perspective drawing of another embodiment of the VTOL vehicle 100 of FIG. 1, in accordance with an exemplary embodiment of the present invention. In this embodiment, the transport unit 110 comprises a backboard 210 and a cover 212. In the depicted embodiment, the backboard 210 is formed between the first duct 124 and the second duct 126. Also in the depicted embodiment, the backboard 210 is housed within the VTOL vehicle 100 between the first duct 124 and the second duct 126 and between the pods 112, as shown in FIG. 2. The backboard 210 also includes a first end 230 attached to the first duct 124 and a second end 232 attached to the second duct 126, as is also shown in FIG. 2. The cover 212 is coupled to the backboard 210 and covers the backboard 210 and any person on the backboard 210 and any belongings included therewith.

FIG. 3 provides a section view of a portion of the VTOL vehicle 100 embodiment of FIG. 2, namely the backboard 210 and the cover 212 referenced above. As depicted in FIG. 3, the backboard 210 includes an approximately flat surface. The approximately flat surface is configured to allow a person to be placed thereon, for example an injured person to be extracted from rough terrain or a hostile environment. The cover 212 is configured to at least substantially cover the person when placed on the backboard 210. The backboard 210 may also include non-depicted straps and/or other safety restraints, a pillow and/or other head supports, and/or medical, control, and/or other devices in certain embodiments. In addition, in certain embodiments, the backboard 210 may include other, non-depicted features such as additional supports, viewing openings, access openings, openings for weapons and/or other devices, and/or other features. However, this may vary in other embodiments.

The embodiment of the VTOL vehicle 100 and personnel transport backboard and cover 210 depicted in FIGS. 2 and 3 is configured for autonomous injured personnel extraction, although it may also be used for other purposes. For example, an injured soldier or other person can be placed onto the backboard 210 and covered by the cover 212 for protection, and can then be extracted by the VTOL vehicle 100 away from a hostile environment and/or rough or confined terrain. The VTOL vehicle 100 can then autonomously navigate the injured person to a rescue ship or base, or to some other safe location. The VTOL vehicle 100 can do so with the relatively high precision and low acoustic and visual signatures of the VTOL vehicle 100, while potentially avoiding the need for endangering additional personnel and equipment.

FIG. 4 is a perspective drawing of another embodiment of the VTOL vehicle 100 of FIG. 1, in accordance with an exemplary embodiment of the present invention. In the embodiment depicted in FIG. 4, the transport unit 110 comprises a chair 410. In the depicted embodiment, the chair 410 is formed between the first duct 124 and the second duct 126, and is housed on the VTOL vehicle 100 between the first duct 124 and the second duct 126. Also, similar to the backboard 210 and cover 212, the chair 410 includes a first end 430 attached to the first duct 124 and a second end 432 attached to the second duct 126, as is also shown in FIG. 4.

As depicted in FIG. 4, the chair 410 includes a seating surface 412 and a back support 414. The seating surface 412 is preferably approximately flat, and is configured to allow a person to sit thereon, for example when the person is being rapidly deployed into a hostile environment or rough or confined terrain. The back support 414 provides support for the person while seated in the chair 410. The chair 410 may also include one or more accessories 434. For example, in certain embodiments, the accessories 434 may include one or more of the following: straps, seat belts or other restraints, other safety devices, supports, a control stick, and/or a pitch compensation rotation device, among various other possible accessories 434. In certain embodiments, the chair may also rotate to compensate vehicle pitch attitudes in flight while maintaining the passenger in a forward looking position.

Also, as depicted in FIG. 4, the chair 410 may at least partially take the place of the sensor 114, one of the pods 112, and/or the capture bar 118 in a preferred embodiment. In certain embodiments, the sensor 114, pod 112, and/or capture bar 118 may be replaced elsewhere on the VTOL vehicle 100 while the chair 410 is implemented as the transport unit 110.

The embodiment of the VTOL vehicle 100 depicted in FIG. 4 is configured for rapid deployment and extraction of personnel in covert operations, although it may also be used for other purposes. For example, a special forces soldier or other personnel can be placed onto the chair 410 and quickly deployed into or extracted from a hostile environment or rough or confined terrain using the VTOL vehicle 100. The VTOL vehicle 100 further provides an autonomous approach and landing suited for such covert operations.

In addition, while situated on the VTOL vehicle 100, the personnel can monitor the surroundings, direct the VTOL vehicle as may be appropriate, and maintain weapons, other self defense devices, and/or other equipment and/or supplies at the ready during transport as may be necessary. The personnel can also quickly mount and dismount from the VTOL vehicle 100 while maintaining an upright posture, an awareness of the surroundings, and control of weapons, other self defenses, and/or other equipment and/or supplies that may be necessary. Moreover, the VTOL vehicle 100 can autonomously navigate the personnel into the hostile environment or rough or confined terrain with the relatively high precision and low acoustic and visual signatures of the VTOL vehicle 100, while potentially avoiding the need for endangering additional personnel and equipment.

As noted above, in one preferred embodiment, the transport unit 110 can be converted between multiple configurations, such as the backboard 210 of FIGS. 2 and 3 and/or the chair 410 of FIG. 4. For example, when conversion of the transport unit 110 from a backboard 210 to a chair is required, the backboard 210 and cover 212, along with a front pod 112, a sensor 114, and/or a capture bar 118, may be removed from the VTOL vehicle 100 and replaced by a chair 410. Conversely, when conversion of the transport unit 110 from a chair 410 to a backboard 210 and cover 212 is required, the chair 410 may be removed from the VTOL vehicle 100 and replaced with a backboard 210 and cover 212, along with a front pod 112, a sensor 114, and/or a capture bar 118.

These steps may be performed, for example, through the use of non-depicted dovetail assemblies that couple the various configurations of the transport unit 110 to the body 102 and between the first and second ducts 124, 126, in one preferred embodiment. For example, the VTOL vehicle may utilize dovetail assemblies and/or other components and/or other features from the various vehicle embodiments depicted and described in the co-pending, commonly owned and assigned U.S. patent application Ser. No. 11/338,558 (Goossen, Double Ducted Hovering Air-Vehicle, Pub. No. U.S. 2006/0192047A1), and incorporated herein by reference.

It will be appreciated that the conversion techniques may vary. In addition, as noted above, in other embodiments the transport unit 110 may be fixed in its configuration. For example, in certain embodiments, the transport unit 110 may be fixed as a backboard and cover such as the backboard 210 and cover 212 of FIGS. 2 and 3, or as a chair such as the chair 410 of FIG. 4, or as another configuration. The transport unit 110 can take various other different configurations, and/or can be converted between these configurations and/or various other configurations, in certain embodiments.

Accordingly, improved VTOL vehicles are provided for transporting personnel. These VTOL vehicles provide for improved covert deployment or extraction of special forces personnel or extraction of injured personnel from rough terrain or a hostile environment, among other functions, with the autonomous navigation, relatively high precision, and relatively low acoustic and visual signature of a VTOL vehicle. For example, the embodiment of the backboard 210 allows for rapid and protected extraction of injured personnel out of hostile conditions or rough terrain, and without placing additional personnel or equipment in harm's way. The embodiment of the chair 410 allows for rapid deployment or extraction of personnel in covert operations in which the personnel can be readily aware of his or her surroundings and prepared for defensive actions, also without placing additional personnel or equipment in harm's way. In addition, the convertibility feature of the transport unit in a preferred embodiment between different configurations provides flexibility and additional potential benefits for the VTOL vehicles.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A vertical take-off and landing (VTOL) vehicle comprising:
a first thruster;
a first duct configured to direct airflow generated by the first thruster;
a second thruster;
a second duct configured to direct airflow generated by the second thruster; and
a transport unit formed between the first duct and the second duct and configured to transport a person or another payload.

2. The VTOL vehicle of claim 1, wherein the transport unit comprises:
a first end attached to the first duct; and
a second end attached to the second duct.

3. The VTOL vehicle of claim 1, wherein the first duct and the second duct are aligned along a lateral plane.

4. The VTOL vehicle of claim 1, wherein the transport unit comprises a backboard and a cover.

5. The VTOL vehicle of claim 1, wherein the transport unit comprises a chair.

6. The VTOL vehicle of claim 5, wherein the chair comprises one or more accessories selected from the group consisting of: straps, restraints, a control stick, and a pitch compensation rotation device.

7. The VTOL vehicle of claim 1, wherein:
the first thruster comprises a first fan configured to rotate in a first direction; and
the second thruster comprises a second fan configured to rotate in a second direction that is counter to the first direction.

8. The VTOL vehicle of claim 7, wherein the first fan and the second fan are configured to be coupled to and powered by an engine.

9. A vertical take-off and landing (VTOL) vehicle comprising:
a body;
a first fan housed within the body and configured to rotate in a first direction;
a first duct housed within the body and configured to direct airflow generated by the first fan;
a second fan housed within the body and configured to rotate in a second direction that is counter to the first direction;
a second duct configured to direct airflow generated by the second fan; and
a transport unit housed within the body between the first duct and the second duct and configured to transport a person or another payload.

10. The VTOL vehicle of claim 9, wherein the transport unit comprises:
a first end attached to the first duct; and
a second end attached to the second duct.

11. The VTOL vehicle of claim 9, wherein the first duct and the second duct are aligned along a lateral plane.

12. The VTOL vehicle of claim 9, wherein the transport unit comprises a backboard and a cover.

13. The VTOL vehicle of claim 9, wherein the transport unit comprises a chair.

14. The VTOL vehicle of claim 13, wherein the chair comprises one or more accessories selected from the group consisting of: straps, restraints, a control stick, and a pitch compensation rotation device.

15. The VTOL vehicle of claim 9, wherein the first fan and the second fan are configured to be coupled to and powered by an engine.

16. A vertical take-off and landing (VTOL) vehicle comprising:
a body;
a first fan housed within the body and configured to rotate in a first direction;
a first duct housed within the body and configured to direct airflow generated by the first fan;
a second fan housed within the body and configured to rotate in a second direction that is counter to the first direction;
a second duct housed within the body and configured to direct airflow generated by the second fan; and
a transport unit housed within the body between the first duct and the second duct and adaptable between:
a first configuration, in which the transport unit comprises a backboard and a cover; and
a second configuration, in which the transport unit comprises a chair.

17. The VTOL vehicle of claim 16, wherein the transport unit comprises:
a first end attached to the first duct; and
a second end attached to the second duct.

18. The VTOL vehicle of claim 17, wherein the first duct and the second duct are aligned along a lateral plane.

19. The VTOL vehicle of claim 16, wherein the first fan and the second fan are configured to be coupled to and powered by an engine.

20. The VTOL vehicle of claim 16, further comprising:
an engine pod formed between the first duct and the second duct.
